(19) United States
(12) Patent Application Publication
(10) Pub. No.: US 2013/0179425 A1
(43) Pub. Date: Jul. 11, 2013

(54) APPARATUS AND METHOD FOR SEARCHING FOR PROGRAM USING RELATED KEYWORD

(71) Applicant: Electronics and Telecommunications Research Institute, Daejeon (KR)

(72) Inventor: Moo Hun LEE, Daejeon (KR)

(73) Assignee: Electronics and Telecommunications Research Institute, Daejeon (KR)

(21) Appl. No.: 13/734,668

(22) Filed: Jan. 4, 2013

(30) Foreign Application Priority Data
Jan. 5, 2012 (KR) 10-2012-0001374

(51) Int. Cl. G06F 17/30

(52) U.S. Cl. CPC G06F 17/30867
USPC 707/710

(57) ABSTRACT

A program search apparatus and method using a related keyword is provided. The program search apparatus may include an interface to extract a search keyword from a program search request, in response to the program search request being received, and a processor to obtain a related keyword with respect to the search keyword, using the extracted search keyword, to search a database for first program information using the obtained related keyword, and to provide found first program information.

### CROSS-REFERENCE TO RELATED APPLICATION

This application claims the benefit of Korean Patent Application No. 10-2012-0001374, filed on Jan. 5, 2012, in the Korean Intellectual Property Office, the disclosure of which is incorporated herein by reference.

### BACKGROUND

1. Field of the Invention

The present invention relates to a technology for searching for and providing more accurate program information, using a related keyword with respect to an input search keyword.

2. Description of the Related Art

Due to a recent increase in a number of broadcasting channels or cable channels, verifying broadcast programs on a channel is difficult, and verifying a time for a predetermined broadcast program is also difficult.

To resolve such difficulties, an Internet Protocol television (IPTV) or a smart TV provides an electronic program guide (EPG) service, or provides a TV program schedule service on the Internet. The EPG service may help a user to obtain information about a desired program readily, by utilizing information about a program title, cast members, producers, weather, and the like. However, in a real TV environment, a service for searching for a broadcast program is unavailable. In particular, although an EPG service based search environment is provided, the user may experience a degree of difficulty in obtaining accurate, desired search results when the user is unaware of an accurate program title, or accurate cast members.

For example, in a conventional EPG search service, when the user desires to search for “The Enchanted Christmas” corresponding to a special edition of “Beauty and the Beast” which is one episode being shown on “The Wonderful World of Disney,” the user should remember the accurate program title “The Wonderful World of Disney” to perform a search. However, when the user fails to recall the program title and remembers only “The Enchanted Christmas” at a point in time when the search is performed, finding the desired broadcast program may be difficult.

Accordingly, there is a need for a technology for enabling a user to search for desired program information more readily.

### SUMMARY

An aspect of the present invention provides an apparatus and method that may search for and provide accurate program information desired by a user, by searching for program information using a related keyword with respect to an input search keyword, although an inaccurate search keyword is input.

According to an aspect of the present invention, there is provided an apparatus for searching for a program using a related keyword, the apparatus including an interface to extract a search keyword from a program search request, in response to the program search request being received, and a processor to obtain a related keyword with respect to the search keyword, using the extracted search keyword, to search a database for first program information using the obtained related keyword, and to provide found first program information.

According to another aspect of the present invention, there is provided a method of searching for a program using a related keyword, the method including extracting a search keyword from a program search request, in response to the program search request being received, obtaining a related keyword with respect to the search keyword, using the extracted search keyword, and searching a database for first program information using the obtained related keyword, and providing found first program information.

According to example embodiments of the present invention, it is possible to search for and provide accurate program information desired by a user, by searching for program information using a related keyword with respect to an input search keyword, although an inaccurate search keyword is input.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a program search system using a related keyword according to an embodiment of the present invention;

FIG. 2 is a block diagram illustrating a program search apparatus using a related keyword according to an embodiment of the present invention;

FIG. 3 is a diagram illustrating an exemplary configuration of a program search apparatus using a related keyword according to an embodiment of the present invention; and

FIG. 4 is a flowchart illustrating a program search method using a related keyword according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

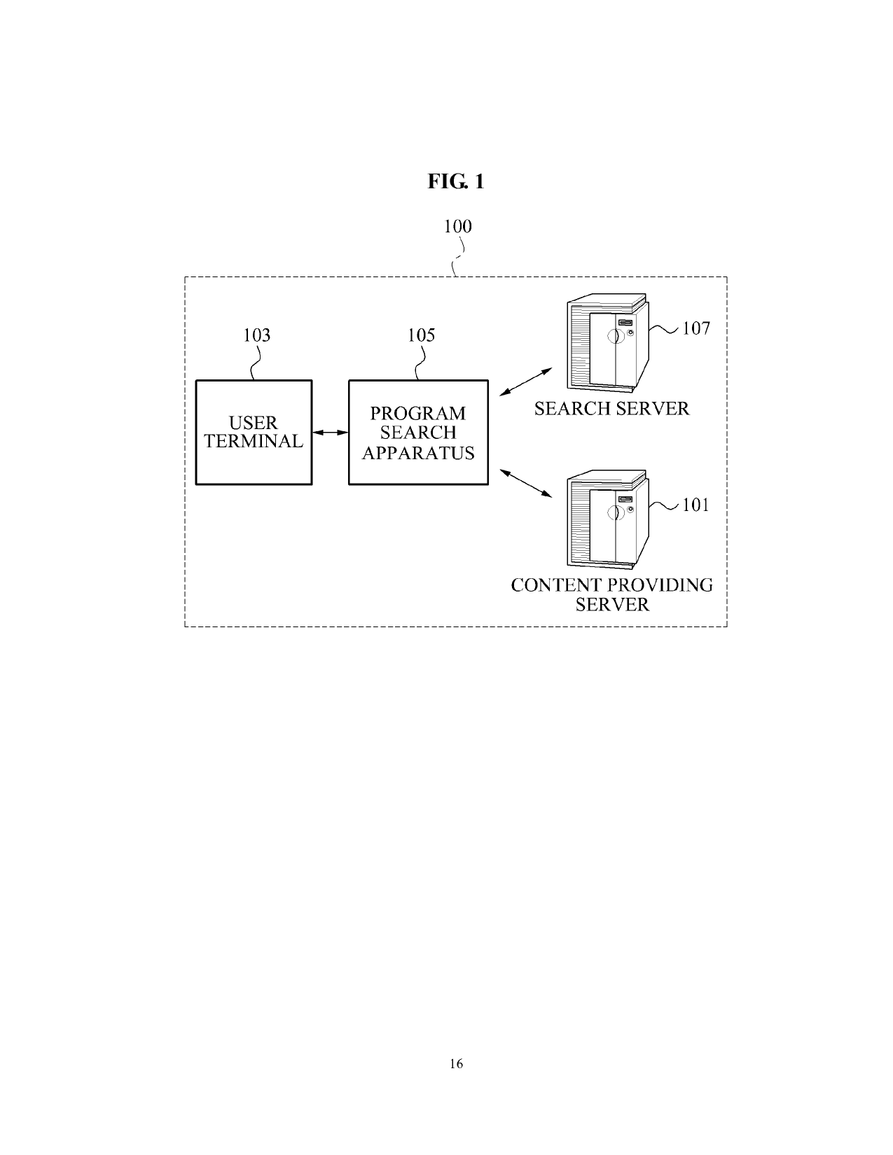

FIG. 1 is a diagram illustrating a program search system 100 using a related keyword according to an embodiment of the present invention.

Referring to FIG. 1, the program search system 100 may include a content information providing server 101, a user terminal 103, a program search apparatus 105, and a search server 107.

The content information providing server 101 may provide program information to the program search apparatus 105, in response to a program information request being received from the program search apparatus 105. Here, the program information may correspond to, for example, an electronic program guide (EPG), and may include at least one of a channel number, a channel name, a program title, classification attributes, and an air time.

The user terminal 103 may correspond to, for example, a smart television (TV), or a wireless terminal, for example, a remote controller, or a smart phone. The user terminal 103 may transmit a program search request to the program search apparatus 105.

The program search apparatus 105 may periodically receive program information, for example, EPG information from the content information providing server 101, and store the received program information in a database, thereby maintaining and managing the program information.

The program search apparatus 105 may receive the program search request through the user terminal 103, or a key input unit disposed in an internal portion of the user terminal 103. The program search apparatus 105 may extract a search keyword from the program search request, in response to the received program search request, search a database (not shown) for program information using the extracted search keyword, and provide found program information to the user terminal 103. Here, the program search apparatus 105 may search the database for the program information partially including the search keyword. For example, the program search apparatus 105 may search the database for program information including the search keyword in at least one of a channel number, a channel name, a program title, classification attributes, and an air time.

In this instance, when program information is absent or a volume of found program information is less than a predetermined value, the program search apparatus 105 may obtain a related keyword from an open application programming interface (API) based search server, in response to a related keyword request transmitted to the open API based search server with respect to the search keyword. Here, the open API based search server may include, for example, a Google server, a Yahoo server, and the like. The program search apparatus 105 may re-search the database for program information using the obtained related keyword, and may provide found program information to the user terminal 103, thereby searching for and providing accurate program information desired by the user although an inaccurate search keyword is input.

When the related keyword request with respect to the search keyword is received from the program search apparatus 105, the search server 107 may provide a related keyword associated with the search keyword to the program search apparatus 105, in response to the related keyword request received.

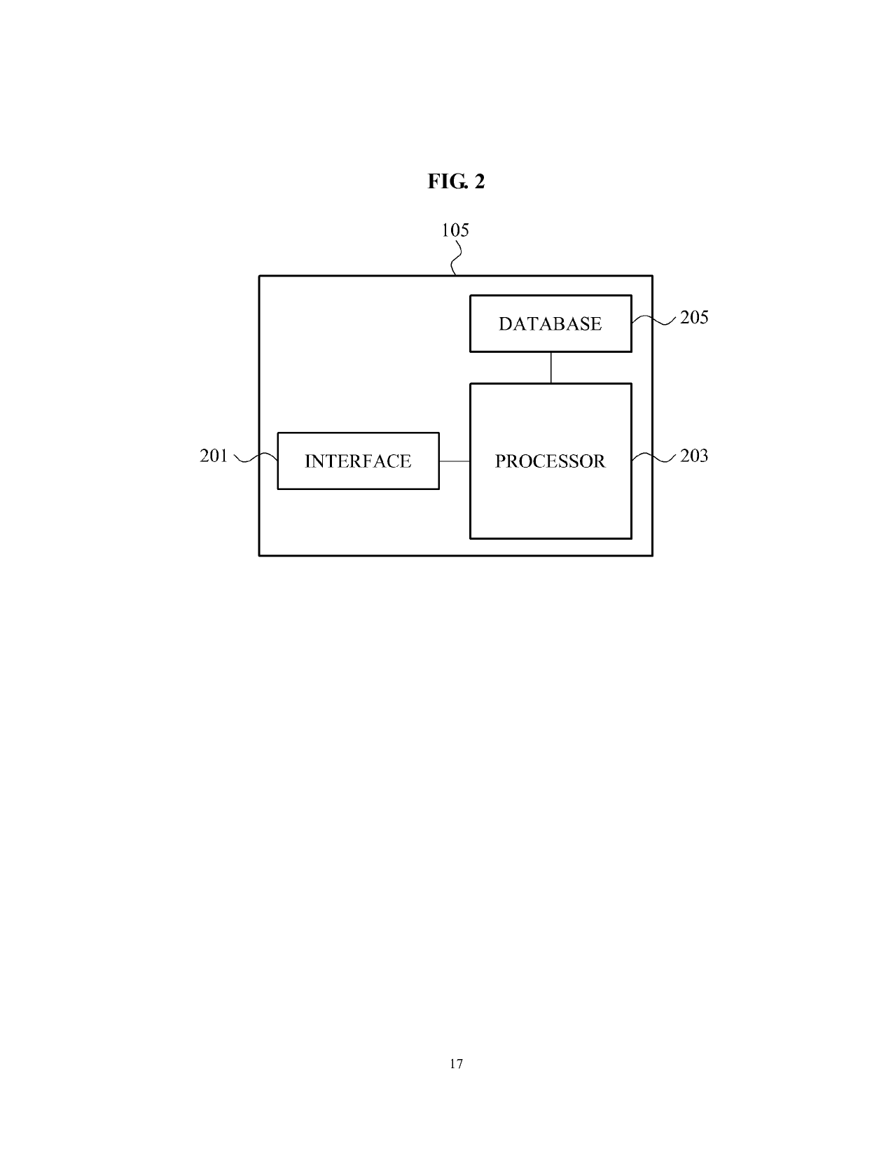

FIG. 2 is a block diagram illustrating a program search apparatus 105 using a related keyword according to an embodiment of the present invention.

Referring to FIG. 2, the program search apparatus 105 may include an interface 201, a processor 203, and a database 205.

The interface 201 may extract a search keyword from a program search request, in response to the program search request being received, and may store the extracted search keyword in the database 205. The interface 201 may provide a search field through a display unit (not shown), and may receive the program search request when a search keyword is input into the search field.

In addition, the interface 201 may receive an extension request with respect to the search keyword, along with the program search request.

The processor 203 may obtain a related keyword with respect to the search keyword, using the extracted search keyword, search the database 205 for first program information using the obtained related keyword, and provide found first program information through the display unit.

In this instance, the processor 203 may obtain the related keyword by receiving the related keyword from an open API based search server, in response to a related keyword request transmitted to the open API based search server with respect to the search keyword. Here, the open API may refer to externally publishing a service provided by a predetermined system in a form of API, and in general, may refer to publishing the service in a form of a web service.

For example, the processor 203 may receive a related keyword “America's Next Top Model” from the search server, in response to a related keyword request transmitted to the search server with respect to a search keyword “ANTM”. In addition, the processor 203 may receive a related keyword “Saturday Night Live” from the search server with respect to a search keyword “SNL.” The processor 203 may also receive, from the search server, related keywords “The Wonderful World of Disney,” “Beauty and the Beast,” and the like with respect to a search keyword “The Enchanted Christmas.”

Although the processor 203 may obtain a related keyword from an external search server, a scheme of obtaining the related keyword is not limited thereto. For example, the processor 203 may obtain a related keyword based on a search keyword previously input.

Before the related keyword is obtained, the processor 203 may determine whether an extension of the search keyword is necessary. When the extension is necessary, the processor 203 may obtain a related keyword extended from the search keyword. In this instance, the processor 203 may determine that the extension is necessary when second program information is absent or a volume of found second program information is less than a predetermined value as a result of searching the database 205 for the second program information associated with the search keyword. Conversely, when the volume of the found second program information is greater than or equal to the predetermined value, the processor 203 may determine that the extension is unnecessary, and may provide the second program information in lieu of the first program information.

When an extension request with respect to the search keyword is received through the interface 201, the processor 203 may obtain the related keyword using the search keyword, irrespective of whether the extension of the search keyword is necessary, for example, search results of the second program information associated with the search keyword, that is, a volume of found second program information.

When performing a search for the first program information, the processor 203 may extract a partial keyword, for example, a program title, from obtained related keywords, search the database 205 for program information using the extracted partial keyword, and provide a list of found program information. The processor 203 may change a channel to a program associated with an input selection, in response to the selection input with respect to the list of the program information, thereby enabling the user to search for and access a desired program readily.

In addition, the processor 203 may periodically receive program information, for example, EPG information, from a content information providing server (not shown), and may store the received program information in the database 205, thereby updating the program information to maintain recent information.

The database 205 may store program information provided by the content information providing server. In addition, the database 205 may also store search keywords extracted by the interface 201.

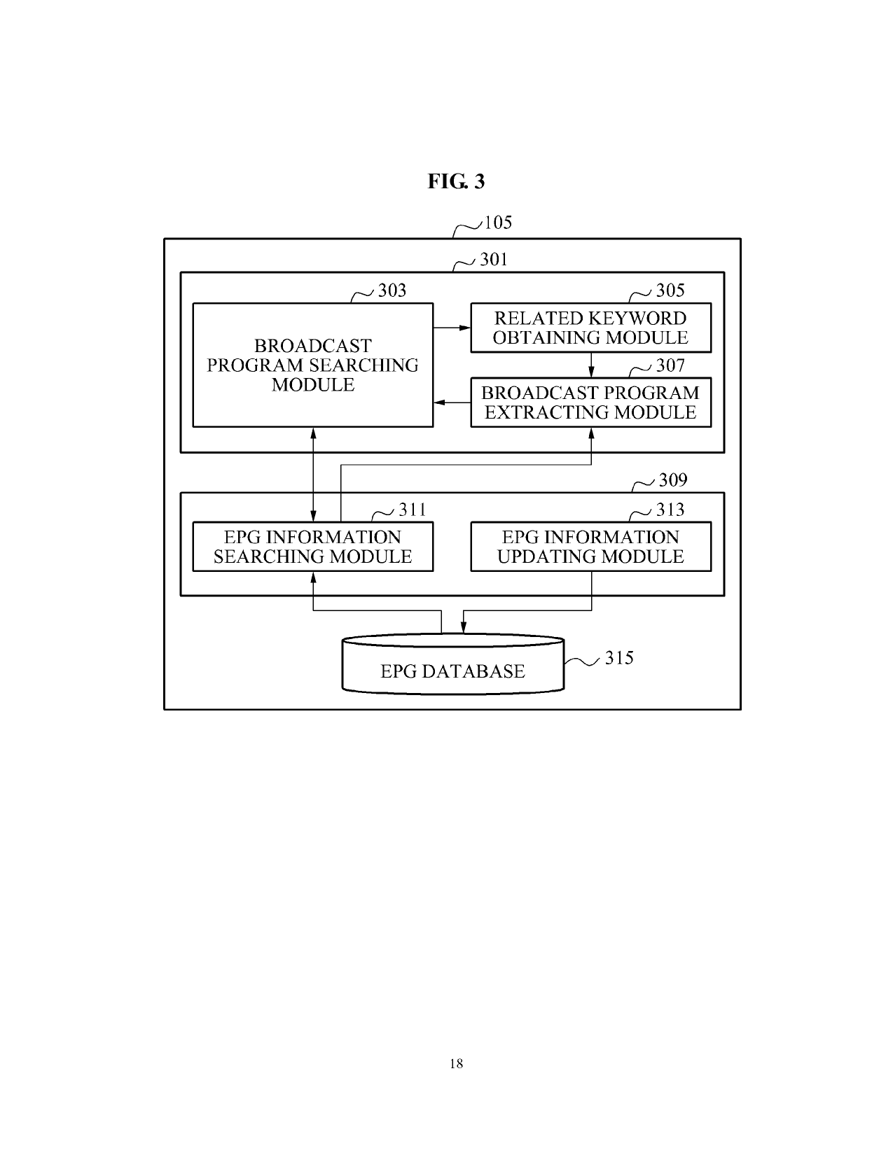

FIG. 3 is a diagram illustrating an exemplary configuration of a program search apparatus 105 using a related keyword according to an embodiment of the present invention.

Referring to FIG. 3, the program search apparatus 105 may include an EPG search unit 301, and an EPG information management unit 309.

The EPG search unit 301 may include a broadcast program searching module 303, a related keyword obtaining unit 305, and a broadcast program extracting module 307.

The broadcast program searching module 303 may receive a search keyword from a user in response to a search request being received from the user, extract index words to be used for a search from the search keyword, and transfer the extracted index words to an EPG information searching module 311. The broadcast program searching module 303 may receive search results from the EPG information searching module 311, determine whether the search keyword is to be extended, based on the received search results, and request an extension of the search keyword by transferring the search keyword to the related keyword obtaining module 305 when the extension is necessary.

When the extension request with respect to the search keyword is received from the broadcast program searching module 303, the related keyword obtaining module 305 may generate a query suitable for an open API format of a predetermined portal site, and may request a related keyword by transmitting, through the predetermined portal site, the generated query to a search server that manages the predetermined portal site. The related keyword obtaining module 305 may receive the related keyword from the search server, and may transfer the received related keyword to the broadcast program extracting module 307.

The broadcast program extracting module 307 may receive the related keyword from the related keyword obtaining module 305, and may search for and provide program information associated with the related keyword, by comparing the received related keyword to program information, for example, a program title, stored in an EPG database 315.

The EPG information management unit 309 may include the EPG information searching module 311, and an EPG information updating module 313.

The EPG information searching module 311 may perform a search by generating the search keyword transferred from the broadcast program searching module 303 to be a query in a form that may be directed to the EPG database 315, and may return search results to the broadcast program searching module 303.

The EPG information updating module 313 may periodically collect EPG data from an EPG information providing server, and may store the collected EPG data in the EPG database 315, thereby maintaining and managing the EPG information to be up-to-date.

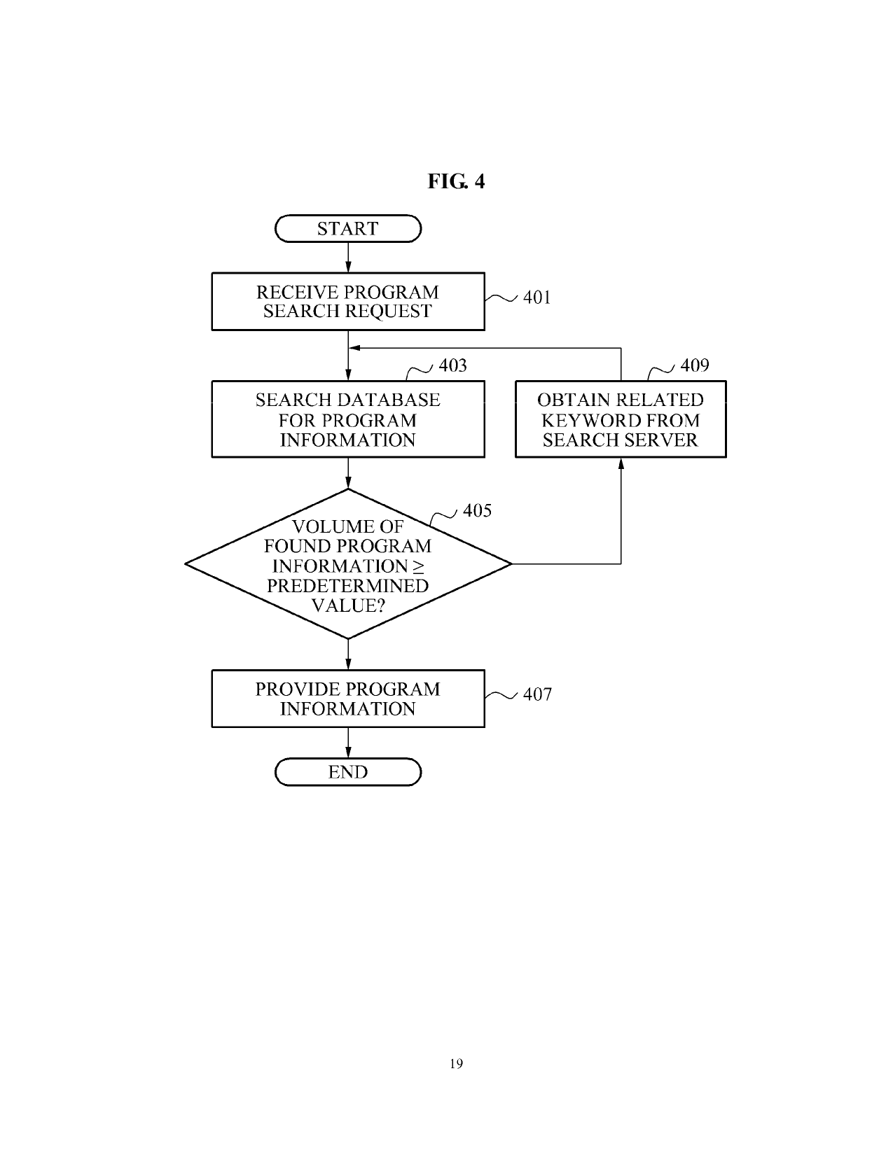

FIG. 4 is a flowchart illustrating a program search method using a related keyword according to an embodiment of the present invention.

Referring to FIG. 4, in operation 401, a program search apparatus may receive a program search request through a user terminal, or a key input unit disposed in an internal portion of the user terminal. Here, the user terminal may include, for example, a smart TV, and a wireless terminal. The program search apparatus may extract a search keyword from the received program search request.

In operation 403, the program search apparatus may search a database for program information associated with the search keyword. In this instance, the program search apparatus may search the database for program information partially including the search keyword. For example, the program search apparatus may search the database for program information including the search keyword in at least one of a channel number, a channel name, a program title, classification attributes, and an air time. The program search apparatus may determine whether an extension of the search keyword is necessary, based on the search results.

When a volume of found program information is determined to be greater than or equal to a predetermined value through operation 405, the program search apparatus may determine that the extension is unnecessary, and may provide a list of the found program information in operation 407.

In this instance, the program search apparatus may change a channel to a program associated with an input selection, in response to the selection input with respect to the list of the program information.

Conversely, when program information is absent, or the volume of the found program information is less than the predetermined value through operation 405, the program search information may determine that the extension is necessary, and may obtain a related keyword by receiving the related keyword from an open API based search server, in response to a related keyword request transmitted to the search server with respect to the search keyword, in operation 409.

When the related keyword is obtained in operation 409, the program search apparatus may iteratively perform operations 403, 405, and 407, using the related keyword.

When a extension request with respect to the search keyword is received, the program search apparatus may obtain the related keyword from the search server using the search keyword, irrespective of whether the extension of the search keyword is necessary, for example, search results of the program information associated with the search keyword, that is, the volume of the found program information.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for searching for a program using a related keyword, the apparatus comprising:
an interface to extract a search keyword from a program search request, in response to the program search request being received; and
a processor to obtain a related keyword with respect to the search keyword, using the extracted search keyword, to search a database for first program information using the obtained related keyword, and to provide found first program information.

2. The apparatus of claim 1, wherein the processor obtains the related keyword, by receiving the related keyword from an open application programming interface (API) based search server, in response to a related keyword request transmitted to the open API based search server with respect to the search keyword.

3. The apparatus of claim 1, wherein the processor determines whether an extension of the search keyword is necessary, and obtains a related keyword extended from the search keyword when the extension is necessary.

4. The apparatus of claim 3, wherein the processor determines that the extension is necessary when second program information is unfound or an amount of found second program information is less than a predetermined value as a result of searching the database for the second program information associated with the search keyword.

5. The apparatus of claim 4, wherein the processor determines that the extension is unnecessary when the amount of the second program information is greater than or equal to the predetermined value, and provides the second program information in lieu of the first program information.

6. The apparatus of claim 1, wherein, when an extension request with respect to the search keyword is received through the interface, the processor obtains the related keyword using the extracted search keyword, irrespective of whether an extension of the search keyword is necessary.

7. A method of searching for a program using a related keyword, the method comprising:
extracting a search keyword from a program search request, in response to the program search request being received;
obtaining a related keyword with respect to the search keyword, using the extracted search keyword; and
searching a database for first program information using the obtained related keyword, and providing found first program information.

8. The method of claim 7, wherein the obtaining comprises obtaining the related keyword, by receiving the related keyword from an open application programming interface (API) based search server, in response to a related keyword request transmitted to the open API based search server with respect to the search keyword.

9. The method of claim 7, wherein the obtaining comprises:
determining whether an extension of the search keyword is necessary; and
obtaining a related keyword extended from the search keyword when the extension is necessary.

10. The method of claim 9, wherein the determining comprises determining that the extension is necessary when second program information is unfound or an amount of found second program information is less than a predetermined value as a result of searching the database for the second program information associated with the search keyword.

11. The method of claim 10, wherein the determining comprises determining that the extension is unnecessary when the amount of the second program information is greater than or equal to the predetermined value, and
wherein
the method further comprises providing the second program information in lieu of the first program information.

12. The method of claim 7, wherein the obtaining comprises obtaining the related keyword using the extracted search keyword, irrespective of whether an extension of the search keyword is necessary, when an extension request with respect to the search keyword is received through the interface.
